(19) United States
(12) Patent Application Publication
(10) Pub. No.: US 2012/0328148 A1
(43) Pub. Date: Dec. 27, 2012

(54) METHOD AND SYSTEM FOR SECURE IMAGE MANAGEMENT

(76) Inventors: Grey William Doherty, Poscoe Uale Sourth (AU); David Paul Chadwick, Ngunnawal ACT (AU); John Trebse, Begumgris Victoria (AU)

(21) Appl. No.: 13/169,180

(22) Filed: Jun. 27, 2011

(51) Int. Cl. G06K 9/00

(52) U.S. Cl. 382/100

(57) ABSTRACT

A method and computer device for managing imagery loaded in an image management system. The method includes analyzing the imagery loaded within the image management system, searching the imagery for one or more images, and displaying images found as a result of searching the imagery. Analyzing includes selecting an image to analyze, authenticating the selected image, and securely uploading an authenticated image into the image management system. Analyzing also includes performing a hashing operation on the selected image. Securely uploading an authenticated image includes, uploading a successfully authenticated into the image management system, including uploading a text file with metadata for the selected image, appending a generated hash for the selected image original to the uploaded text file, uploading the selected image, comparing the generated hash with a hash of the uploaded selected image, and generating an error message if the generated hash does not match the hash of the uploaded selected image.

### BACKGROUND

1. Field

The instant disclosure relates generally to shared imagery management, and more particularly, to storing, managing, searching and retrieving content, such as still, and motion imagery, audio recordings, and documents.

2. Description of the Related Art

The capture and management of imagery and related metadata, such as forensics imagery and other digital content, including photographs, sketches, video recordings, photogrametrics, audio recordings, writings and documents, and fingerprint images, is critical to the efficient and successful processes involved in the associated tasks to which the imagery is related, e.g., forensic case management and law enforcement investigation. Conventional imagery management systems are based on conventional film production and processing techniques, which often are relatively expensive and time consuming. As digital cameras and the digital images they produce rapidly replace conventional imaging technology, the ability to capture, store, manage and analyze imagery and associated metadata, becomes more important to successful activities that often rely on such imagery, such as forensic case management and law enforcement investigation.

### SUMMARY

Disclosed is a method, system and computing device for managing imagery loaded in an image management system. The method includes analyzing the imagery loaded within the image management system, searching the imagery for at least one image based on at least one keyword, and displaying any images found as a result of searching the imagery. According to an embodiment, analyzing the imagery includes selecting an image to analyze, authenticating the selected image, and securely uploading an authenticated image into the image management system. Analyzing the imagery includes performing at least one hashing operation on at least a portion of the selected image. Securely uploading an authenticated image into the image management system includes, if the selected image is successfully authenticated, uploading the image into the image management system, wherein uploading the selected image includes uploading a text file with metadata for the selected image, appending a generated hash for the selected image original to the uploaded text file, uploading the selected image, comparing the generated hash with a hash of the uploaded selected image, and generating an error message if the generated hash does not match the hash of the uploaded selected image.

### BRIEF DESCRIPTION OF THE DRAWINGS

FIG. 1 is a flow diagram of a method for storing and managing imagery according to an embodiment;

FIG. 2 is a flow diagram of a method for ingesting imagery within the method of FIG. 1;

FIG. 3 is a flow diagram of a method for updating metadata within the method of FIG. 1; and

FIG. 4 is a schematic view of an apparatus configured to store and manage imagery according to an embodiment.

### DETAILED DESCRIPTION

In the following description, like reference numerals indicate like components to enhance the understanding of the disclosed methods and systems through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the disclosure.

As used in this description, the terms “component,” “module,” and “system,” are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes, such as in accordance with a signal having one or more data packets, e.g., data from one component interacting with another component in a local system, distributed system, and/or across a network, such as the Internet, with other systems by way of the signal.

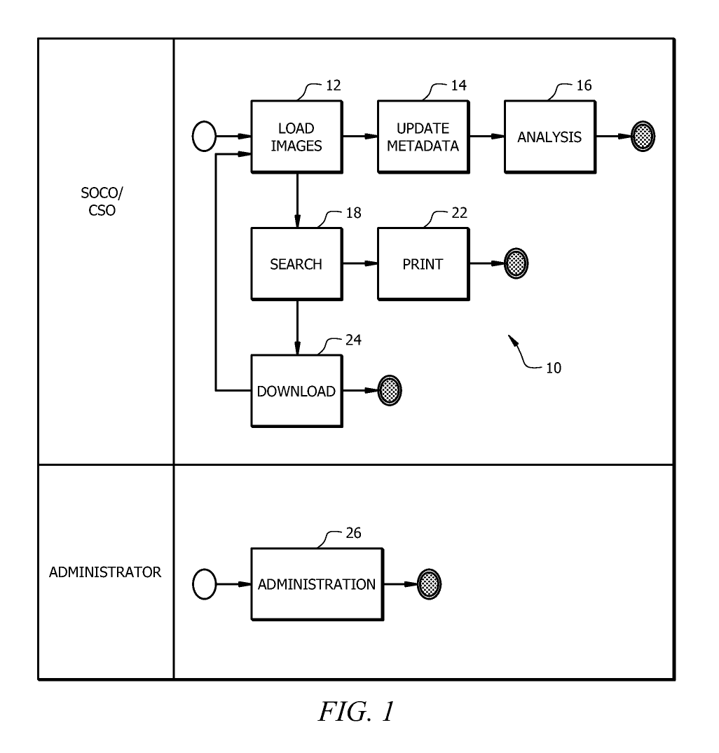

FIG. 1 is a flow diagram of a method 10 for storing and managing imagery. The imagery management method and system facilitates system users in ingesting and managing images and associated notes and other metadata, e.g., photographs, video recordings, photogrammetry, sketches, and other information collected in the course of a police officer's or employees responsibilities. Although the image management method 10 and system generally will be described in the context of fingerprint imagery management of crime scene information, it should be understand that the imagery management methods and system described herein can be used with any suitable imagery and related metadata, such as forensics imagery and other digital content, including photographs, sketches, video recordings, photogrametrics, audio recordings, writings and documents, and fingerprint images.

The method 10 includes a step 12 of loading images into the imagery management system, as will be discussed in greater detail hereinbelow. The images are loaded into the imagery management system from an appropriate image capturing device, such as a camera, via a suitable connection between the image capturing device and the imagery management system.

The method 10 also includes a step 14 of updating imagery metadata into the imagery management system. As will be discussed in greater detail hereinbelow, in addition to mandatory metadata input during image upload, users can at any time update the defined non-mandatory metadata as the information is available.

The method 10 also includes a step 16 of analyzing the imagery in the imagery management system. As will be discussed in greater detail hereinbelow, according to an embodiment, the process of analyzing imagery, such as fingerprints and other suitable imagery, involves Access Latent, Latent Comparison, and Verification. In general, Access Latent involves a technician or other suitable individual examining the images to determine which images are suitable for comparison and printing (if required). Latent Comparison involves a technician examining images (e.g., a photograph) to determine if the images are suitable for upload to an Automated Fingerprint Identification System (AFIS) or other suitable organization. Verification involves the search results returned from the AFIS being updated to the imagery management system, then verified by one or more verification experts.

The method 10 also includes a step 18 of searching the imagery in the imagery management system. According to an embodiment, as part of the searching step 18, a search facility within the imagery management system allows appropriate users, e.g., Forensic Services Group (FSG) users, to locate forensic case images stored in the imagery management system during the processing life-cycle of the stored crime scene images. According to an embodiment, the images cannot be modified and are never deleted from the imagery management system.

The method 10 also includes a step 22 of printing the imagery in the imagery management system. The printing step 22 provides users the option of requesting a hardcopy print of selected images from a Minilab or other appropriate external location, or printing selected images via local printers.

The method 10 also includes a step 24 of downloading the imagery from the imagery management system, provided that the user is authorized to do so. The downloading step 24 allows users to select and retrieve images stored in the imagery management system to a working drive for external processing, such as for transferring images to the AFIS or in preparation of a court briefing or appearance.

The method 10 also includes a step 26 of administering the imagery in the imagery management system. As will be discussed in greater detail hereinbelow, the imagery management system must includes an administration module to manage system users and their roles, as well as manage the various day-to-day system administrative activities, such as administering user access, monitoring and reporting, and the management of sensitive or protected images.

The loading step 12 typically involves the activities undertaken by one or more Police Officers or Employees, Crime Scene Officers (CSOs) or other appropriate individuals to upload to the imagery management system crime scene images captured in a camera or other appropriate image capturing device, and to record notes about these images as metadata. The images may be related to one or more cases and can be grouped and indentified by indexes or case numbers associated with the content or images.

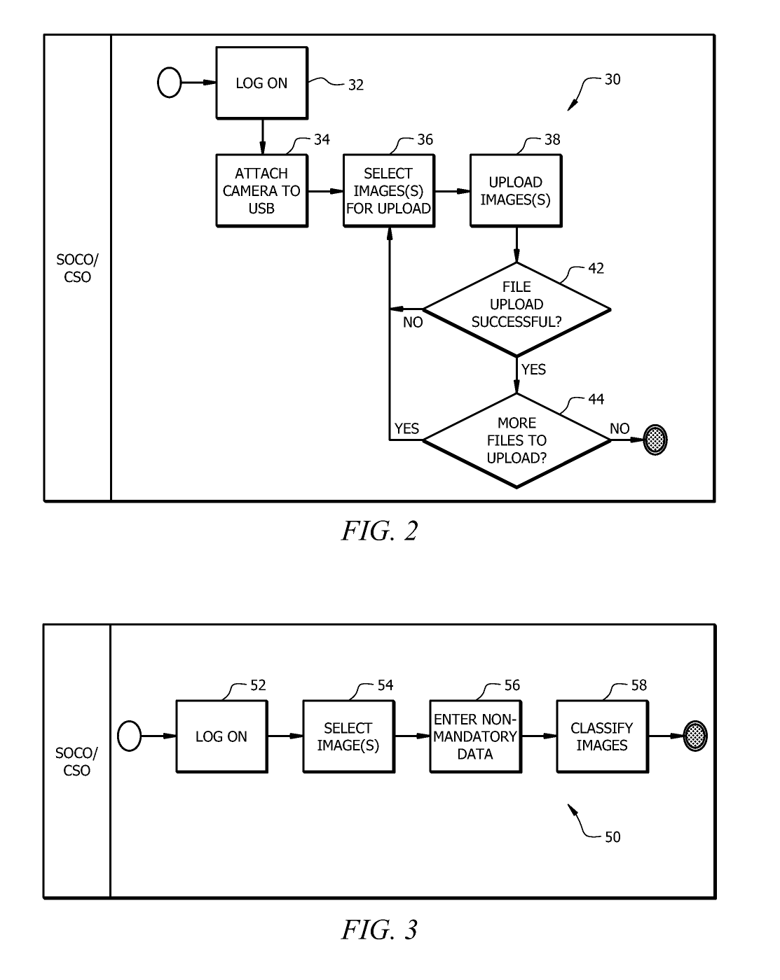

FIG. 2 is a flow diagram of a method 30 for the step 12 of loading images into an imagery management system. The method 30 includes a step 32 of logging on or logging in to the imagery management system. The log on process and mechanism can be any suitable log on protocol that allows appropriate users access to the imagery management system. After logging in, the user accesses an Upload Image function.

The method 30 also includes a step 34 of coupling a camera or other device containing images to the imagery management system, e.g., via a USB cable or other suitable coupling element. Once the user accesses the Upload Image function within the imagery management system, the user then connects the camera or other device containing the stored imagery therein to the imagery management system, e.g., by connecting the camera to an appropriate device storing and/or executing the imagery management system, such as a computer workstation. The imagery management system then displays all of the images from the camera that are available for uploading.

The method 30 also includes a step 36 of selecting the images (and related files or other data) to be uploaded to the imagery management system. Once the images contained within the camera are displayed, the user then selects the images to be uploaded.

The method 30 also includes a step 38 of uploading the selected images to the imagery management system. To move a selected image for upload from the camera to a central file storage repository within the imagery management system, the imagery management system first performs a hashing operation or other suitable operation to authenticate and protect the data integrity of the image selected for upload. Hashing ensures that files uploaded and then stored within the imagery management system are identical to the source file (on the camera). Hashing also ensures that imagery that may be presented as evidence subsequently has not been tampered with. A suitable hashing operation often is required to comply with one or more digital image processing standards as defined by ISO or other standards bodies.

Once the user selects the images to be uploaded, the selected images are uploaded from the camera to the imagery management system. Initially, the imagery management system uploads a text file with the metadata for the selected image. Then, a hash, e.g., an MD5 hash, is generated from the original file on the camera and appended to the uploaded text file. Next, the image is uploaded from the camera to the imagery management system. The imagery management system then performs a check to make sure the generated hash matches that of the original uploaded image file. If the generated hash does not match the original, the imagery management system generates an error message and the upload process must be performed again.

Once the selected image has been authenticated, the imagery management system stores the original authenticated image in a primary image storage location and creates a working copy of the authenticated image for storage in a secondary image storage location. The imagery management system then merges the uploaded metadata text file with the working copy of the authenticated image. The original authenticated image stored in the primary image storage location is the untouched image as captured by the camera. The working copy of the authenticated image stored in the secondary image storage location is the image that is to be used and involved in future processes by the imagery management system, as will be discussed in greater detail hereinbelow.

Typically, the user can continues uploading images until there is an indication from either the camera and/or from the imagery management system that there are no more images to be uploaded.

The user also can input or otherwise add metadata associated with the upload image(s), e.g., mandatory metadata. For example, various details related to the image can be added, including case number (CN), incident type, folder number, job number, event number, date, photographer name, photographer serial number, uploader name, uploader serial number, image category, image notes, print caption and other suitable information.

The method 30 also includes a step 42 of determining whether the image upload step has been successful. If the determining step 42 determines that the image/file upload step has not been successful (N), e.g., if the uploaded image does not match the original image from the camera, an appropriate error message is displayed. If the file cannot be uploaded by the user due to repeated error messages, the files would be secured via traditional methods, such as physically storing the digital media card in accordance with local policies and procedures. The method 30 then returns to the step 36 of selecting the image or images for uploading and uploading the selected images/files to the imagery management system (step 38). If the determining step 42 determines that the image/file upload step has been successful (Y), an “Upload Successful” indication is displayed, and the method 30 proceeds to a step 44 of determining whether there are more images or files to be uploaded. If the user indicates that there are more images or files to upload (Y), the method 30 returns to the step 36 of selecting the image or images for uploading and uploading the selected images/files to the imagery management system (step 38). If the user indicates that there are no more images to upload (N), the method 30 is complete.

The updating step 14 involves updating imagery metadata in the imagery management system. In addition to mandatory metadata input during image upload (as discussed hereinabove), users can at any time update the defined non-mandatory metadata as the information is available, as will be discussed in greater detail hereinbelow.

FIG. 3 is a flow diagram of a method 50 for the step 14 of updating imagery metadata into the imagery management system. In addition to metadata input during image the image upload process, e.g., mandatory metadata, users can at any time update certain metadata, e.g., defined non-mandatory metadata, as such information is available.

The method 50 includes a step 52 of logging on or logging in to the imagery management system. The user log on procedure is similar to the initial log on procedure described hereinabove.

The method 50 also includes a step 54 of selecting the images to which new metadata will be added or existing metadata will be updated. The user can search particular case folders in which images are contained and select the target images in the selected folder. One image or multiple images can be selected at a time for metadata update. Also, images in the selected folder that are not accessible by the user are not displayed.

The method 50 also includes a step 56 of updating the metadata. Mandatory metadata fields, i.e., metadata fields entered during the initial image upload process, as described hereinabove, are locked for editing except by administrators. Also, a set of validation rules can be applied to the updated non-mandatory metadata. The updated non-mandatory metadata can include any suitable non-mandatory metadata, such as the event number, the case number, the photographer registered serial number, the major crime folder number, the job number, relevant system-based identification numbers, the image category, the image status, a print caption, and an image note.

The method 50 also includes a step 58 of classifying the images. The user can classify the images according to any one or more suitable security classification schemes as defined by the imagery management system. For example, images can be classified using rules-based classification, automated classification, roles-based (type of case) or roles-based permission classification, standard security term classification, or on an image by image basis. However, users have access only to images within their user security classification.

The analyzing step 16 involves analyzing the imagery in the imagery management system. For images in which imagery analysis involves comparison techniques, the images can be analyzed, assessed and compared using conventional method. Such images include fingerprints, tool marks, shoeprints and tire prints, and other suitable images whose analysis can involve comparison techniques.

For imagery such as fingerprint images, the process of analyzing imagery can involve Access Latent, which includes a technician or other suitable individual examining the fingerprint images to determine which images are suitable for comparison and for printing (if required). The process of analyzing imagery also can involve Latent Comparison, which includes a technician examining images (e.g., a photograph) to determine if the images are suitable for uploading to the Automated Fingerprint Identification System (AFIS) or other appropriate external image analysis organization. The process of analyzing imagery also can involve Verification, which includes the search results returned from the AFIS being updated in the imagery management system, then verified by one or more verification experts.

As discussed hereinabove, the method 10 includes the step 18 of searching the imagery in the imagery management system. According to an embodiment, as part of the searching step 18, a search facility within the imagery management system allows appropriate users to locate forensic case images stored in the imagery management system during the processing life-cycle of stored crime scene images. As discussed hereinabove, the images cannot be modified and are never deleted from the imagery management system.

To perform a search, an appropriate user can enter one or more keywords in a search box displayed by the imagery management system. Only images accessible by the requestor are displayed.

As discussed hereinabove, the method 10 includes the step 22 of printing the imagery in the imagery management system. The printing step 22 provides users the option of requesting a hardcopy print of selected images from an appropriate external location or printing selected images in local printers.

As discussed hereinabove, the method 10 includes the step 24 of downloading the imagery in the imagery management system. The downloading step 24 allows appropriate users to select and retrieve images stored in the imagery management system to a working drive for external processing, such as for transferring images to the AFIS or in preparation of a court briefing or appearance, or for some other suitable reason.

To download images from the imagery management system, the user selects the images for downloading and selects the “download” option. The user then selects the download type, e.g., an AFIS download, which is a straight copy of the image without the related or associated metadata. Alternatively, the user can select a court brief download, which adds a text block caption to the image copy from a court brief caption field. The court brief download also removes the associated metadata, except for the camera data. Alternatively, the user can select an external download, which adds a standard text block including a copyright notice and statement that the downloaded image is not to be used for court or evidence. The external download also removes all associated metadata, except for the camera data.

As discussed hereinabove, the method 10 includes the step 26 of administering the imagery in the imagery management system. The imagery management system can include an administration module to manage system users and their roles, as well as the various day-to-day system administrative activities, such as administering user access, monitoring and reporting, and the management of sensitive or protected images.

With respect to administering user access, the initial logon identification and password establishment, and the on-going password administration, is managed via the existing administration process. An appropriate user always needs to have a valid user account to access the imagery management system. After a new user is established, the administrator of the imagery management system assigns the user to the user's correct role. The role determines the access rights for specific system functions and image access corresponding to the security classification.

Access is managed through groups/roles, which are assigned with specific access rights. Users with the same role have the same access rights. In addition to roles-based assignment of access, the administrator of the imagery management system can set access rights of users individually. While the majority of users have their access permissions set by their role, there is the ability to modify these for individual users. Therefore, it is possible to create a protected or sensitive image archive and only allow access to certain individuals.

With respect to monitoring and reporting, information related to the history of user access and life-cycle processing images can be flexibly retrieved for reporting. All actions typically are logged in a suitable database, such as a Microsoft SQL server database management system.

The administrator of the imagery management system creates and saves reports for specific requirements. Pre-configured reports can be generated in the imagery management system by authorized administration users. Various activities that are recorded in an audit log can be included in reports, including Login, Logout, Pages viewed, Images deleted, Text edited, Images uploaded, Images downloaded, Searches Performed, Prints, and other suitable activities.

With respect to the management of sensitive or protected images, the administrator of the imagery management system is able to create an archive, such as a Forensic Archive, for storage of sensitive or protected images. Such images can be viewed by limited users.

With respect to general administration, administrative facilities are included for the deletion of uploaded images. For example, only users with administrative rights can mark images for deletion. For security purposes, the administrator of the imagery management system is the one who initiates a batch process that removes images marked as “delete” from the imagery management system.

Administrative facilities also are included to configure incident types. The list for incident type can be updated by the administrator of the imagery management system through the uploading of an appropriate text file. Similarly, administrative facilities also are included to configure image category. The list for image category can be updated by the administrator of the imagery management system.

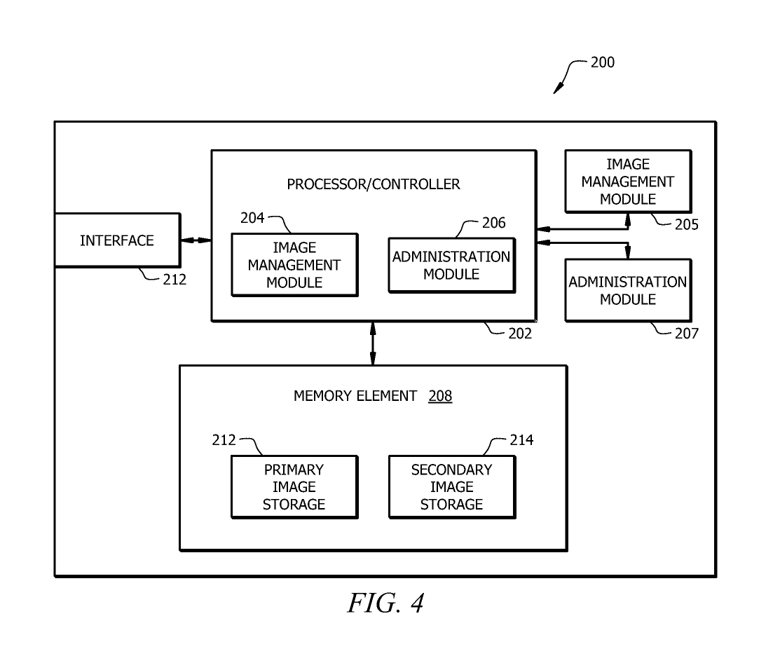

FIG. 4 is a schematic view of a system or apparatus 200 configured to store, and manage imagery according to an embodiment. The apparatus 200 is configured to capture, manage and analyze imagery, such as fingerprint imagery and other forensics imagery, and associated metadata according to an embodiment. The apparatus 200 can be any apparatus, device or computing environment suitable for capturing and managing imagery and associated metadata according to an embodiment. For example, the apparatus 200 can be or be contained within any suitable computer system, including a mainframe computer and/or a general or special purpose computer.

The apparatus 200 includes one or more general purpose (host) controllers or processors 202 that, in general, processes instructions, data and other information received by the apparatus 200. The processor 202 also manages the movement of various instructional or informational flows between various components within the apparatus 200. The processor 202 can include an image management module 204 that is configured to execute and perform the imagery capture and management processes described herein. Alternatively, the apparatus 200 can include a standalone image management module 205 coupled to the processor 202. Also, the processor 202 can include an administration module 206 that is configured to execute and perform the imagery management system administration processes described herein. Alternatively, the apparatus 200 can include a standalone administration module 207 coupled to the processor 202.

The apparatus 200 also can include a memory element or content storage element 208, coupled to the processor 202, for storing instructions, data and other information received and/or created by the apparatus 200. The memory element 208 includes a primary image storage location 212 for storage of original authenticated images and a secondary image storage location 214 for storage of working copy images. The primary image storage location 212 typically is engineered, manufactured or otherwise configured so that a hashed image cannot be modified or tampered with once the hashed image has been uploaded. In addition to the memory element 208, the apparatus 200 can include at least one type of memory or memory unit (not shown) within the processor 202 for storing processing instructions and/or information received and/or created by the apparatus 200.

The apparatus 200 also can include one or more interfaces 212 for receiving instructions, imagery, data and other information. It should be understood that the interface 212 can be a single input/output interface, or the apparatus 200 can include separate input and output interfaces.

It should be understood that the apparatus 200 is configured in such a way that one or more of the image management module 204, the administration module 206 and other portions of the processor 202 can be readily interfaced, e.g., via the interface 212 or in any other suitable manner, with one or more external functional components so that the features of these external functional components are fully integrated with the features of the apparatus 200 described herein. Such external functional components can include one or more facial recognition feature components, real time video streaming feature components (including facial isolation from within the video streams), motion detection and reporting feature components, number plate recognition feature components, video analytics feature components, and other feature components, including feature components that may be developed in the future. Also, it should be understood that the apparatus 200 is configured in such a way that one or more of the image management module 204, the administration module 206 and other portions of the processor 202 can be readily customized to allow for full process integration of the processes of one or more of these feature components.

One or more of the processor 202, the image management module 204, the image management module 205, the administration module 206, the administration module 207, the memory element 208 and the interface 212 can be comprised partially or completely of any suitable structure or arrangement, e.g., one or more integrated circuits. Also, it should be understood that the apparatus 200 includes other components, hardware and software (not shown) that are used for the operation of other features and functions of the apparatus 200 not specifically described herein.

The apparatus 200 can be partially or completely configured in the form of hardware circuitry and/or other hardware components within a larger device or group of components. Alternatively, the apparatus 200 can be partially or completely configured in the form of software, e.g., as processing instructions and/or one or more sets of logic or computer code. In such configuration, the logic or processing instructions typically are stored in a data storage device, e.g., the memory element 208 or other suitable data storage device (not shown). The data storage device typically is coupled to a processor or controller, e.g., the processor 202. The processor accesses the necessary instructions from the data storage element and executes the instructions or transfers the instructions to the appropriate location within the apparatus 200.

One or more of the image management module 204, the image management module 205, the administration module 206 and the administration module 207 can be implemented in software, hardware, firmware, or any combination thereof. In certain embodiments, the module(s) may be implemented in software or firmware that is stored in a memory and/or associated components and that are executed by the processor 202, or any other processor(s) or suitable instruction execution system. In software or firmware embodiments, the logic may be written in any suitable computer language. One of ordinary skill in the art will appreciate that any process or method descriptions associated with the operation of the image management module 204, the image management module 205, the administration module 206 and the administration module 207 may represent modules, segments, logic or portions of code which include one or more executable instructions for implementing logical functions or steps in the process. It should be further appreciated that any logical functions may be executed out of order from that described, including substantially concurrently or in reverse order, depending on the functionality involved, as would be understood by those reasonably skilled in the art. Furthermore, the modules may be embodied in any non-transitory computer readable medium for use by or in connection with an instruction execution system, apparatus, or device, such as a computer-based system, processor-containing system, or other system that can fetch the instructions from the instruction execution system, apparatus, or device and execute the instructions.

The functions described may be implemented in hardware, software, firmware, or any combination thereof. If implemented in software, the functions may be stored on or transmitted as one or more instructions or code on a non-transitory computer-readable medium. The methods illustrated in the figures may be implemented in a general, multi-purpose or single purpose processor. Such a processor will execute instructions, either at the assembly, compiled or machine-level, to perform that process. Those instructions can be written by one of ordinary skill in the art following the description of the figures and stored or transmitted on a non-transitory computer readable medium. The instructions may also be created using source code or any other known computer-aided design tool. A non-transitory computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), and the like.

It will be apparent to those skilled in the art that many changes and substitutions can be made to the embodiments described herein without departing from the spirit and scope of the disclosure as defined by the appended claims and their full scope of equivalents.

1. A method for managing imagery loaded in an image management system, the method comprising:
analyzing the imagery loaded within the image management system, including
selecting an image to analyze,
authenticating the selected image, wherein authenticating the selected image includes performing at least one hashing operation on at least a portion of the selected image,
if the selected image is successfully authenticated, uploading the image into the image management system, wherein uploading the selected image includes
uploading a text file with metadata for the selected image,
appending a generated hash for the selected image original to the uploaded text file,
uploading the selected image,
comparing the generated hash with a hash of the uploaded selected image, and
generating an error message if the generated hash does not match the hash of the uploaded selected image;
searching the imagery for at least one image based on at least one keyword; and
displaying any images found as a result of searching the imagery.

2. The method as recited in claim 1, wherein uploading the selected image includes
storing the uploaded selected image in a primary image storage location within the image management system,
creating a working copy of the uploaded selected image,
storing the working copy of the uploaded selected image in a secondary image storage location within the image management system, and
merging the working copy of the uploaded selected image with an uploaded metadata text file for the selected image.

3. The method as recited in claim 1, wherein analyzing the imagery loaded within the image management system includes moving the selected image to an image analysis queue for review by a technician, wherein a technician can determine whether the selected image is suitable for comparison,
if the selected image is determined not to be suitable for comparison, the selected image can be tagged as not suitable for comparison, and
if the selected image is determined to be suitable for comparison, the technician can determine whether the selected image is suitable for onscreen comparison.

4. The method as recited in claim 3, wherein
if the selected image is determined to be suitable for onscreen comparison, the selected image can be tagged as suitable for comparison/onscreen,
if the selected image is determined not to be suitable for onscreen comparison, the selected image can be tagged as suitable for comparison/print,
wherein the technician can determine if the selected image is suitable for an AFIS search,
if the selected image is determined not to be suitable for an AFIS search, the selected image can be tagged as not suitable for AFIS search,
if the selected image is determined to be suitable for an AFIS search, the selected image can be tagged as suitable for AFIS search,
wherein a verification expert can review the results of an AFIS search of the selected image.

5. The method as recited in claim 1, further comprising updating imagery metadata for imagery loaded in the image management system, wherein updating imagery metadata includes selecting an image and entering metadata associated with the selected image.

6. The method as recited in claim 1, further comprising uploading imagery into the image management system via an imagery containing device coupled to the image management system, wherein uploading imagery can include inputting imagery metadata for imagery uploaded into the image management system.

7. The method as recited in claim 1, further comprising administering the access of users to the image management system.

8. The method as recited in claim 1, wherein images tagged as suitable for AFIS search can be searched by the AFIS for possible matches with at least one image in the AFIS system.

9. The method as recited in claim 5, wherein a verification expert can review the results of an AFIS search.

10. A computing device, comprising:
a processor;
a memory element coupled to the processor, wherein the memory element includes cache memory having a plurality of cache memory levels; and
an image management module coupled to the processor and to the memory element, wherein the image management module is configured to
analyze the imagery loaded within the image management system, including
selecting an image to analyze,
authenticating the selected image, wherein the image management module is configured to perform hashing operations, and wherein the image management module authenticating the selected image includes the image management module performing at least one hashing operation on at least a portion of the selected image,
if the selected image is successfully authenticated, uploading the image into the image management system, wherein the image management module uploading the selected image includes the image management module
uploading a text file with metadata for the selected image,
appending a generated hash for the selected image original to the uploaded text file,
uploading the selected image,
comparing the generated hash with a hash of the uploaded selected image, and
generating an error message if the generated hash does not match the hash of the uploaded selected image,
search the imagery for at least one image based on at least one keyword; and
display any images found as a result of searching the imagery.

11. The computing device as recited in claim 10, wherein the memory element includes a primary image storage location and a secondary image storage location, and wherein the image management module uploading the selected image includes the image management module
storing the uploaded selected image in the primary image storage location within the image management system,
creating a working copy of the uploaded selected image,
storing the working copy of the uploaded selected image in the secondary image storage location within the image management system, and
merging the working copy of the uploaded selected image with an uploaded metadata text file for the selected image.

12. The computing device as recited in claim 10, wherein the image management module authenticating the selected image includes
moving the selected image to an image analysis queue for review by a technician,
wherein a technician can determine whether the selected image is suitable for comparison,
if the selected image is determined not to be suitable for comparison, the selected image can be tagged as not suitable for comparison,
if the selected image is determined to be suitable for comparison, the technician can determine whether the selected image is suitable for onscreen comparison.

13. The computing device as recited in claim 12, wherein
if the selected image is determined to be suitable for onscreen comparison, the selected image can be tagged as suitable for comparison/onscreen,
if the selected image is determined not to be suitable for onscreen comparison, the selected image can be tagged as suitable for comparison/print,
wherein the technician can determine if the selected image is suitable for an AFIS search,
if the selected image is determined not to be suitable for an AFIS search, the selected image can be tagged as not suitable for AFIS search,
if the selected image is determined to be suitable for an AFIS search, the selected image can be tagged as suitable for AFIS search,
wherein a verification expert can review the results of an AFIS search of the selected image.

14. The computing device as recited in claim 10, wherein the image management module is further configured to update imagery metadata for imagery loaded in the image management system, wherein updating imagery metadata include selecting an image and entering metadata associated with the selected image.

15. The computing device as recited in claim 10, wherein the image management module is further configured to upload imagery into the image management system via an imagery containing device coupled to the image management system.

16. The computing device as recited in claim 10, further comprising an administration module coupled to the processor and to the memory element, wherein the administration module is configured to administer the access of users to the image management system.

17. The computing device as recited in claim 16, wherein at least one of the image management module and the administration module is configured to interface with an external function component in such a way that features of the external function component are integrated with the computing device.

18. The computing device as recited in claim 10, wherein images tagged as suitable for AFIS search can be searched by the AFIS for possible matches with at least one image in the AFIS system.

19. A non-transitory computer readable medium having instructions stored thereon which, when executed by a processor, carry out a method for managing imagery, the instructions comprising:
instructions for analyzing the imagery loaded within the image management system, including
instructions for selecting an image to analyze,
instructions for authenticating the selected image, including instructions for performing at least one hashing operation on at least a portion of the selected image,
instructions for uploading the image into the image management system if the selected image is successfully authenticated, wherein
if the selected image is successfully authenticated, uploading the image into the image management system, wherein uploading the selected image includes
uploading a text file with metadata for the selected image,
appending a generated hash for the selected image original to the uploaded text file,
uploading the selected image,
comparing the generated hash with a hash of the uploaded selected image, and
generating an error message if the generated hash does not match the hash of the uploaded selected image,
instructions for searching the imagery for at least one image based on at least one keyword; and.
instructions for displaying any images found as a result of searching the imagery.

20. The non-transitory computer readable medium as recited in claim 19, wherein uploading the selected image includes
instructions for storing the uploaded selected image in a primary image storage location within the image management system,
instructions for creating a working copy of the uploaded selected image,
instructions for storing the working copy of the uploaded selected image in a secondary image storage location within the image management system, and
instructions for merging the working copy of the uploaded selected image with an uploaded metadata text file for the selected image.
